(19) United States
(12) Patent Application Publication
(10) Pub. No.: US 2026/0023621 A1
(43) Pub. Date: Jan. 22, 2026

(54) Systems and Methods to Optimize Resource Management for Virtual Machines

(71) Applicant: SAP SE, Walldorf (DE)

(72) Inventors: Tim Breitenbach, Mitgenfeld (DE); Bartosz Wilkusz, Mannheim (DE); Patrick Jahnke, Leimen (DE)

(21) Appl. No.: 18/776,782

(22) Filed: Jul. 18, 2024

(51) Int. Cl. G06F 9/50; G06F 9/455

(52) U.S. Cl. CPC G06F 9/5077; G06F 9/45558; G06F 9/5072; G06F 2009/45583

(57) ABSTRACT

Described herein are techniques for analyzing historic time-series data to determine right-size commissioned resources from a software provider such as a hyperscaler. The historic time-series data may be analyzed to determine whether a commissioned resource should be upsized or downsized based on historical usage of the resource. Advantages to right-sizing a commissioned resource include improved performance and reduced spending.

### BACKGROUND

Unless otherwise indicated herein, the approaches described in this section are not prior art to the claims in this application and are not admitted to be prior art by inclusion in this section.

Hyperscalers have become a popular option for flexible computing and storage instances in the cloud. Customers can purchase resources like CPU, memory, storage or network usage and the provider can in turn commission these resources to the customers. If too many resources are commissioned, the customer has wasted money. On the other hand, if too few resources are commissioned, performance can be an issue. Thus, there is a need to commission the right amount of resources in order to balance performance and cost.

### BRIEF DESCRIPTION OF THE DRAWINGS

FIG. 1 illustrates a system for generating a service tier recommendation according to some embodiments.

FIG. 2 illustrates a candidate for downsizing according to some embodiments.

FIG. 3 illustrates a candidate for not changing the commissioned resource class according to some embodiments.

FIG. 4 illustrates a candidate for upsizing the commissioned resource class according to some embodiments.

FIG. 5 illustrates a workflow for determining whether to downsize a VM according to some embodiments.

FIG. 6 depicts a simplified block diagram of an example computer system, which can be used to implement some of the techniques described in the foregoing disclosure.

### DETAILED DESCRIPTION

Described herein are hyperscaler solutions, more particularly methods and apparatuses to determine the right amount of computing resources to commission. Resources may include CPU, memory, storage, and network usage to name a few. Often times with hyperscalers, costs are calculated based on the resources commissioned by the user and not the actual used resources. As such, there exists a financial interest for the customer in rightsizing the commissioned resources. The challenge in downsizing (i.e., commission less resources) is to figure out if and by how much we can lower the commissioned resources without risking a significant drop in performance. Similarly, the challenge in upsizing (i.e., commission more resources) is to figure out if and by how much we should raise the commissioned resources to improve performance while keeping costs in mind. Rightsizing the commissioned resources can have benefits such as improved performance and reduced cost.

In some embodiments, a solution is described where historic time-series data associated with the consumption of a resource on a virtual machine (VM) is analyzed to provide a recommendation for the current service tier commissioned. The recommendation may be if the current service tier should be downgraded, upgraded, or remain the same. Downgraded is used herein synonymous to downsized and upgraded is synonymous to upsized. A service provider may commission a resource on a VM to a customer based on the service tier purchased by said customer. Each service tier has a price and corresponds to a quantity of the resource that may be consumed by the customer. For example, with storage, service tier 1 may have a cost and provides 50 GB of storage, service tier 2 has a higher cost and provides 100 GB of storage, and service tier 3 has the highest cost and provides 200 GB of storage. To analyze whether the commissioned resource should be downgraded, data points within the historic time-series data are analyzed to determine whether a downgraded service tier would be able to support the consumption of the customer. Similarly, to analyze whether the commissioned resource should be upgraded, data points within the historic time-series data are analyzed to determine whether the customer's consumption would benefit from an upgraded service tier. In some embodiments, a recommendation to the customer is provided after upgrading and downgrading workflows are both performed.

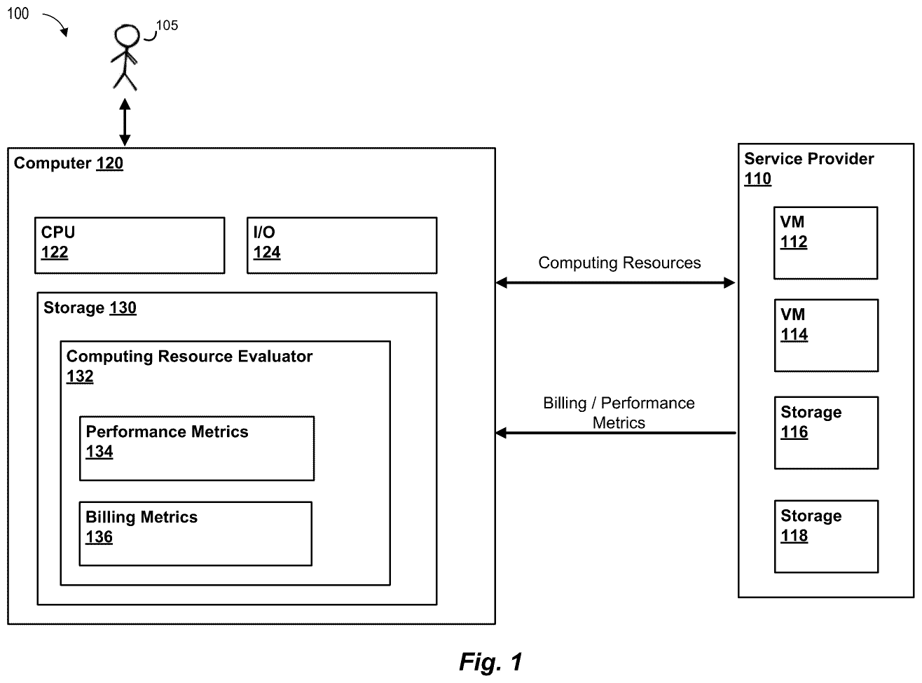

FIG. 1 illustrates a system for generating a service tier recommendation according to some embodiments. System 100 includes user 105. User 105 may be a customer of service provider 110 which offers resources on demand as a service. Resources herein is used generically to include computing resources, storage resources, network resources, memory resources, and any other resources that may be offered by a cloud based service provider. In one example, the service provider may be a hyperscaler. User 105 operates computer 120 which may utilize computing and storage resources within service provider 110. Service provider 110 may include VM 112, VM 114, storage 116, and storage 118. VM 112 and 114 offer flexible computing, memory, or network resources to user 105 while storage 116 and 118 offers flexible cloud storage to user 105. In some embodiments, service provider 110 commissions resources to the user 105 in service tiers. Each service tier corresponds to an amount of the resources that are commissioned to user 105 during a billing cycle or a maximum amount of resources that can be used as a given point in time. Once user 105 has consumed all of the commissioned resources, the service provider 110 may throttle back, reduce, or even the user may be denied the resource entirely. This service model is different than a service model where the user is charged based on actual usage since the user is charged based on what is commissioned instead of actual usage. In general, the fee associated with a service tier increases with the level of service. For example, service tier 1 which commissions less resources than service tier 2 may be less expensive than service tier 2. In other words, service tiers that commission more resources have a higher fee associated with it. The resources commissioned by a user may be set in a resource setting stored by the service provider. The resource setting may be set to the service tier that is being commissioned by the user or the user's account.

Service provider 110 may transmit billing and/or performance metrics of user 105 to computer 120. The billing and performance metrics may in turn be analyzed to determine whether the current resources commissioned to the user is the right size. Computer 120 includes CPU 122, input/output (I/O) 124 and storage 130. Storage 130 may store computing resource evaluator 132, which is a computer application to analyze the billing and performance metrics. Computer resource evaluator 132 stores performance metrics 134 and billing metrics 136. In one embodiment, service provider 110 may periodically transmit billing and performance metrics to computer 120 which in turn stores the received metrics. In another embodiment, computer 120 may transmit a request to service provider 110 who in turn responds with the performance and billing metrics. Performance metrics 134 and billing metrics 136 may be stored as historic time-series data. For example, performance metrics 134 may include time-series data where each data point represents the actual usage of the resource at a particular point in time. Billing metrics 136 may include time-series data where each data point represents the service tier at a particular point in time. The point in time may be a period of time, such as one minute, one hour, or a 24 hour period. Computing resource evaluator 132 may, at the request of user 105, analyze performance metrics 134 and billing metrics 136 to determine whether the resource currently commissioned to the user as represented by a service tier is the right size for the actual usage of the user. Computing resource evaluator 132 may recommend to upsize the resource (upgrade to higher service tier), downsize the resource (downgrade to a lower service tier), or stay at the current service tier. In one embodiment, computing resource evaluator 132 may automatically analyze the data on a predefined interval (such as every week or every month) and provide a recommendation to user 105 as to whether the service tier should be adjusted.

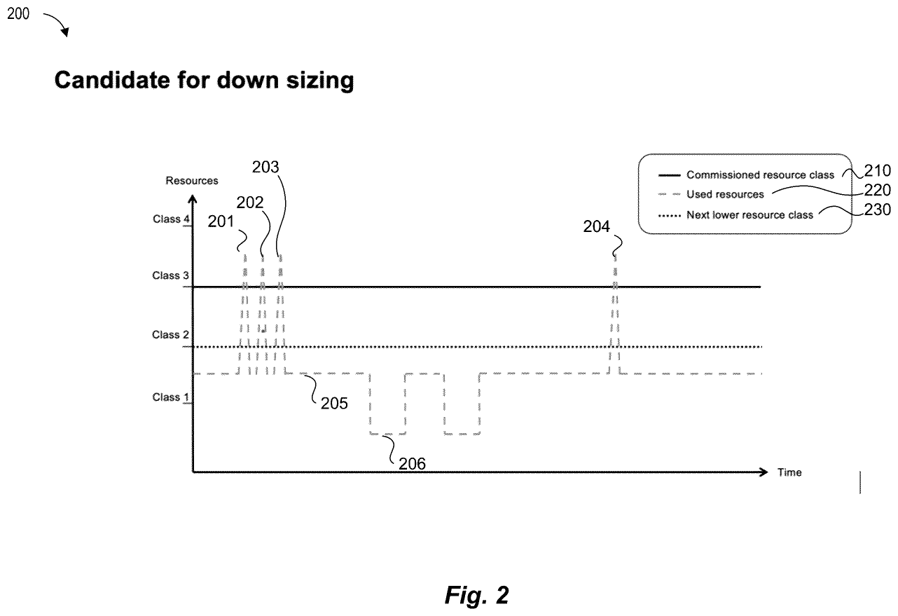

FIG. 2 illustrates a candidate for downsizing according to some embodiments. Graph 200 illustrates the actual usage of a resource over time. The actual usage of resources over time may be stored as historical time-series data and presented in graph 200. As shown, the commissioned resource class 210 (i.e., the commissioned service tier) is class 3 and is represented by the solid line in graph 200. Since the commissioned resource class is class 3, the next lower resource class 230 is class 2, which is represented by the dotted line in graph 200. The actual usage of resources (220) is represented by the dashed line in graph 200. As shown, most of the actual usage is below class 3, except for data points 201-204 where the actual usage spiked above class 3. Depending on the commissioned resource, it is possible for the actual usage to be more than 100%. For example with memory and storage, it may not be possible for actual usage to be above 100% but for resources such as CPU, it is possible to have boost functionality reach more than 100% of the commissioned resources for a short period of time. In some embodiments, computing resource evaluator may analyze the actual usage of resources and the currently commissioned resource class and conclude that this is a good candidate for downgrading the commissioned resource class. The analysis may include discretizing the actual usage by assigning each data point to the smallest resource class that is greater than the actual usage. It may be desirable to essentially round up the actual usage to the next higher resource class so that there is some room for error. For example, the data point 201 may be discretized to class 4 since class 4 is the smallest commissioned resource class with a value that is greater than the actual usage value at data point 201. As another example, data point 205 may be discretized to class 2 while data point 206 may be discretized to class 1. The analysis may examine the percentage of discretized data points that are equal to or less than the next lower resource class to determine whether to downsize. The analysis may also examine the temporally, whether the data points that are greater than the next lower resource class occurred more recently. For example, graph 200 illustrates data points 201-204, which when discretized have a value corresponding to class 4. Since class 4 has a higher value than class 2 which is the next lower resource class, the resource usage at these four data points is higher than the proposed downsizing. However, data points 201-203 occurred a while ago while data point 204 occurred more recently so there appears to be a trend of fewer violations. As such, computing resource evaluator may recommend downsizing the commissioned resource class.

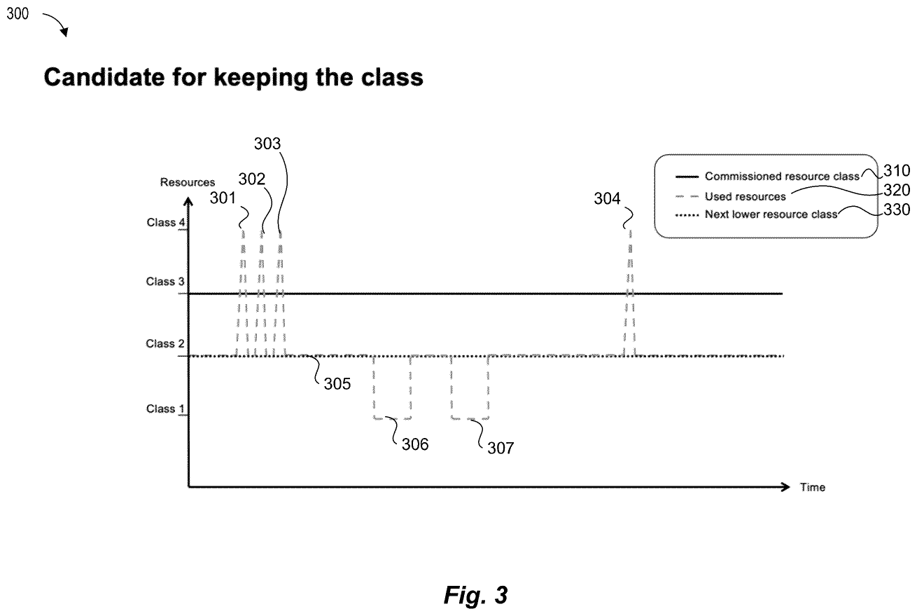

FIG. 3 illustrates a candidate for not changing the commissioned resource class according to some embodiments. Graph 300 illustrates the actual usage of a resource over time. The actual usage of resources over time may be stored as historical time-series data and presented in graph 300. As shown, the commissioned resource class 310 (i.e., the commissioned service tier) is class 3 and is represented by the solid line in graph 300. Since the commissioned resource class is class 3, the next lower resource class 330 is class 2, which is represented by the dotted line in graph 300. The actual usage of resources (320) is represented by the dashed line in graph 300. In some embodiments, computing resource evaluator may analyze the actual usage of resources along with the currently commissioned resource class and conclude that this is a good candidate for keeping the commissioned resource class as it is. As shown, most of the actual usage is at class 2, which means that when the actual usage is discretized, the discretized data points are mostly assigned to class 3. For example, data point 305 would be discretized to class 3, data points 301-304 would be discretized to class 4 and data point 306 would be discretized to class 2. The analysis may examine the percentage of discretized data points that are equal to or less than the next lower resource class to determine whether to downsize. Since the vast majority of data points except for the data points in the valleys of 306 and 307 have a discretized value greater than the next lower class (class 2), this example is a good candidate to keep the commissioned resource class as it is. In one embodiment, computing resource manager may also analyze the commissioned resource class against the actual usage to determine whether the commissioned resource class is adequate based on the historical time-series data. For example, here, the vast majority of the data points, when discretized, are equal to or less than the commissioned resource class (class 3). The computing resource manager may conclude after analysis that class 3, the currently commissioned resource class, is a good fit for the user's actual usage of the commissioned resource

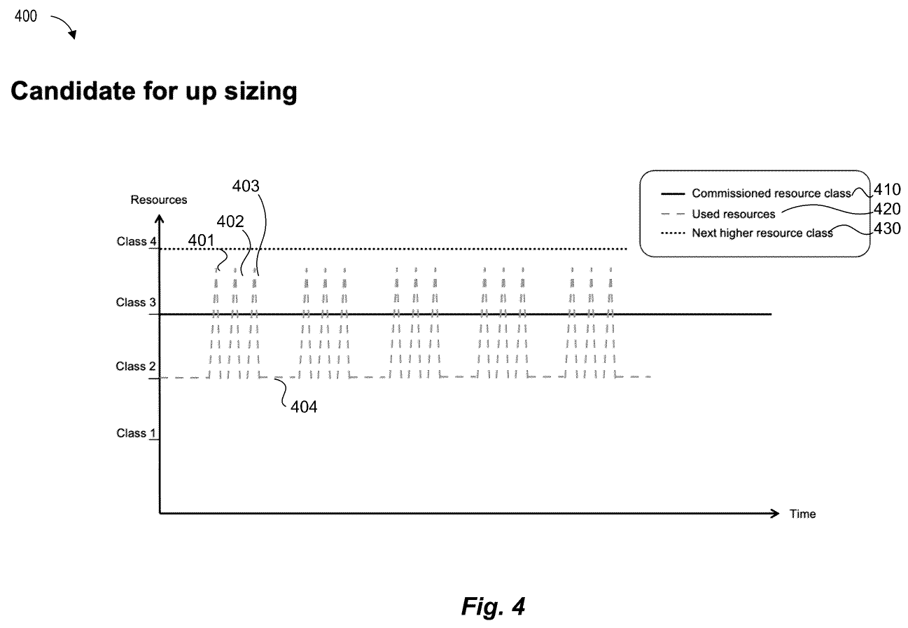

FIG. 4 illustrates a candidate for upsizing the commissioned resource class according to some embodiments. Graph 400 illustrates the actual usage of a resource over time. The actual usage of resources over time may be stored as historical time-series data and presented in graph 400. As shown, the commissioned resource class 410 (i.e., the commissioned service tier) is class 3 and is represented by the solid line in graph 300. Since the commissioned resource class is class 3, the next higher resource class 430 is class 4, which is represented by the dotted line in graph 400. The actual usage of resources (430) is represented by the dashed line in graph 400. In some embodiments, computing resource evaluator may analyze the actual usage of resources along with the currently commissioned resource class and conclude that this is a good candidate for upsizing the commissioned resource class. As shown, there are many peaks such as data points 401-403 where the actual usage of resources is above class 3. When discretized, data points 401-403 will have a value of class 4. There are also a few areas in used resources line 420 where the actual usage is at class 2, such as data point 404. However, given the large number of data points having an actual usage above the commissioned resource class, computing resource evaluator may determine that graph 400 is a good candidate for upsizing the commissioned resource class from class 3 to class 4. By upsizing the commissioned resource class, the actual usage of the resource is less likely be greater than the value corresponding to class 4. This can be beneficial from a performance standpoint because the user is less likely to experience poor performance due to the actual usage being more than the commissioned resource.

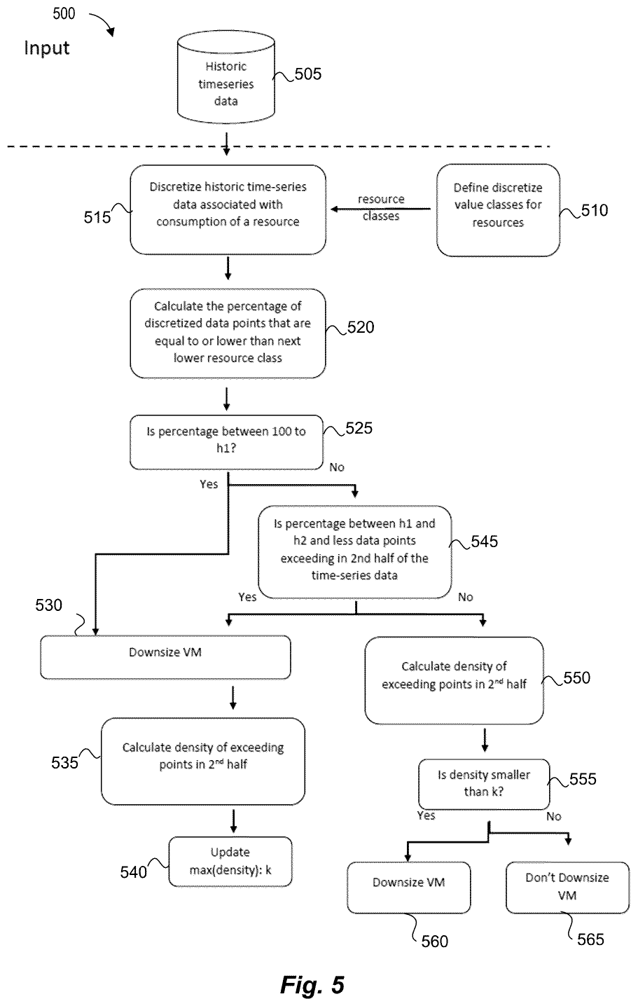

FIG. 5 illustrates a workflow for determining whether to downsize a VM according to some embodiments. Workflow 500 is configured to analyze historic time-series data containing the actual usage of a commissioned resource to provide a recommendation as to whether the commissioned resource should be downsized. While the example here is related to downsizing, the workflow can also be modified to provide a recommendation for upsizing. Details on the changes for upsizing are included below.

Workflow 500 begins by receiving historic time-series data 505. The historic time-series data may include the actual usage of a commissioned resource such as memory, storage, or CPU over a period of time. Each data point within the historic time-series data represents the actual usage of the commissioned resource over a fixed period of time, such as one hour, one day, or one week. Workflow 500 continues by defining the discretize value classes for the resource at 510. The discretized value classes are also known as service tiers. In some examples, the service tiers have already been defined by the service provider and can thus be retrieved from the service provider. In other examples, workflow 500 may define the service tiers based on instructions from the user.

Once the service tiers and the historic time-series data are available, workflow 500 continues by discretizing the historic time-series data at 515. In one embodiment, discretizing the historic time-series data includes assigning a service tier to each data point in the historic time-series data. The service tier assigned to the data point may be the lowest service tier that has a value greater than the actual usage value of the data point. For example, let's assume service tier 1 corresponds to a commissioned resource value of 5, service tier 2 corresponds to a commissioned resource value of 10 and service tier 3 corresponds to a commissioned resource value of 15. If a data point includes an actual usage of value 7, then discretizing the data point would involve assigning the service tier 2 (i.e., commissioned resource value of 10) to the data point since the commissioned resource value of 10 that corresponds to service tier 2 is the smallest service tier that is still larger than the actual usage of value 7. Service tier 1 would be too small with a commissioned resource value of 5 and service tier 3 would be too large since service tier 2 is available. Discretizing the historic time-series data can be advantageous since it reduces the number of possible values for the data points, thus simplifying calculations in the workflow.

Once the historic time-series data has been discretized, workflow 500 continues by calculating the percentage of discretized data points that are equal to or lower than the next lower resource class at 520. For example, if the currently commissioned resource class is 3, then resource class 2 would be the next lower resource class. Similarly, if the currently commissioned resource class is 2, then resource class 1 would be the next lower resource class. In one embodiment, the percentage is calculated by first identifying the number of discretized data points that are equal to or lower than the next lower resource class. The identified data points are then divided by the total number of data points in the historic time-series data. For example, if there are a total of 100 discretized data points in the time-series data and 75 of them have been identified as having a discretized value that is less than or equal to the next lower resource class, then the percentage would be 75%. For upsizing workflow, step 520 would calculate the percentage of discretized data points that are lower than or equal to the next higher resource class. In another embodiment, calculating the percentage can include flagging data points from the discretized time-series data having a discretized value being equal to or less the value corresponding to the downgraded service tier (i.e., next lower resource class). A percentage may then be calculated by summing up the flagged data points and dividing the sum by the total number of data points.

After the percentage has been calculated, workflow 500 continues by determining whether the percentage is within a first range defined as between 100% and a first threshold h1 at 525. In one example, the range can include h1. In another example, the range does not include h1. If the percentage is within this range, this means that the lower resource class would have been sufficient for a large percentage of the historical actual usage since the historical usage rarely went over the lower resource class. Workflow 500 continues by downsizing the VM to the lower resource class at 530. For upsizing workflow, step 520 would upsize the VM to the next higher resource class. After downsizing the VM, workflow 500 updates a maximum density of the second half of the time series data by first calculating the density of exceeding data points in the second half of the time-series data at 540 and then updating the maximum density value with the calculated density at 550. An exceeding data point is a data point with a discretized value that is greater than the next lower resource class. The number of exceeding data points in the second half of the time series data can be calculated by subtracting the number of identified data points in the second half (i.e., data points having a discretized value that is equal to or less than the next lower resource class) from the total data points in the second half. It is advantageous to calculate the density of exceeding data points in the second half because the density may be an indicator of the trend of exceeding data points. For example, if the density of exceeding data points is less in the second half than the first half, then there is a trend of fewer exceeding data points. Similarly, if the density of exceeding data points is more in the second half than the first half, then there is a trend of more exceeding data points. To calculate the density, the data points in the second half can be evaluated to see how many data points are larger than the next lower resource class. These are considered exceeding data points. The number of exceeding data points is then divided by the total number of data points in the second half to calculate a percentage. The percentage is saved as the density of the second half. For upsizing workflow, the density would be calculated by evaluating how many data points are larger than the next higher resource class.

In some embodiments, the definition of the second half of the time-series data may be defined as a period of time, such as less than 6 months. Therefore, if the second half of the time-series data is larger than 6 months, then the second half of the time-series data can be halved again (calculate density for the last ¼ of the time-series data) and again (calculate density for the last ⅛ of the time-series data. This process can be repeated until the second half used for calculating density is smaller than the predefined period of time (e.g., 6 months). Once the density is calculated, it is compared against the global max density k at 540. If the calculated density is greater than the global max density, then the global max density is set to the calculated density. This way, the global max density stores the maximum density of the second half of the VMs that have been downsized.

If the percentage is not between 100 and h1, workflow 500 continues by determining whether the percentage is within a second range defined as between a second predefined threshold h2 and h1. The specifics of whether the second range includes h1 and/or h2 can vary depending on implementation details. Workflow 500 also determines whether there are less exceeding data points in the second half of the time series data at 545. In one embodiment, the number of data points having a discretized value that is equal to or lower than the next lower resource class can be used in the calculation for 545. Instead of determining whether there are less exceeding data points in the second half of the time series, we can instead determine whether there are more data points in the second half of the time series than the first half of the time series that have a discretized value equal to or less than the next lower resource class. This may be advantageous since the data points having a discretized value equal to or less than the next lower resource class have been identified in 520 already. For example, if the first half of the time series data includes 50 data points and 40 of the data points have a discretized value equal to or less than the next lower resource class, then it can be determined that the other 10 data points have a discretized value greater than the next lower resource class and are considered the exceeding data points. If the second half of the time series includes 50 data points and 45 data points have a discretized value equal to or less than the next lower resource class, then by deduction the other 5 data points have a discretized value greater than the next lower resource class and are considered exceeding points. As can be seen in this example, the second half has less exceeding data point (5) versus the first half (10), or alternatively can be said that the second half has more non-exceeding data points (45) versus the first half (40). Differences in the number of exceeding points in the halves (or any other separation of the time period) can be determined by statistical means. Similar to above, the second half may be defined as a period of time, such as less than 6 months. Therefore, if the second half of the time-series data is larger than 6 months, then the second half can be halved again and again until the second half used for calculating the percentage is less than 6 months. If there are less exceeding data points in the second half (meaning that there are more exceeding data points in the first half than in the second half) and the percentage is within the second range, then workflow 500 continues by downsizing the VM to the lower resource class at 530. The density of exceeding data points in the second half is then calculated at 535 and the global max density is updated at 540. Alternatively, if the percentage is less than h2 (can include h2) or if there are more exceeding data points in the second half, then workflow continues by calculating the density of exceeding data points in the second half at 550. For upsizing workflow, step 550 would calculate the density of data points that exceed the next higher resource class. The density is then compared to the global max density at 555. If the percentage is smaller than the global max density (which means that other VMs have been downsized with more exceeding data points in the second half), then the VM is downsized at 560. For upsizing workflow, the VM would be upsized to the next next higher resource class. Alternatively, if the percentage is greater than the global max density, then workflow 500 does not downsize the VM at 565.

In one embodiment, h1 and h2 can be calculated with a business value estimator which is configured to generate a value for h1 and h2 based on the business value. In another embodiment, h1 and h2 can be calculated by collecting the number of customers complaints about the performance of their applications associated to the VMs before and after applying some value of the thresholds for rightsizing for a reasonable period of time. We can divide both intervals into smaller ones and can compare them with statistical means if the number of complaints increases. If the complaints do increase, then the values for h1 and h2 can be adjusted larger. Analogously, we can proceed with any performance metrics (like the duration for solving a small benchmark task) for which we have thresholds that are not allowed to be exceeded (e.g. SLAs or given from experience/technical reasoning). If the performance in the group of downsized VMs decreases such that the new commissioned resources are exceeded or customer complaints increase significantly, we know that the selected h1 and h2 are too small. In one example, we can start with very conservative values h1 and h2 and then decrease accordingly. In addition, we can apply the new rules first to a small subset of customers as a trial, collect customer feedback from the trial, and update the values h1 and h2.

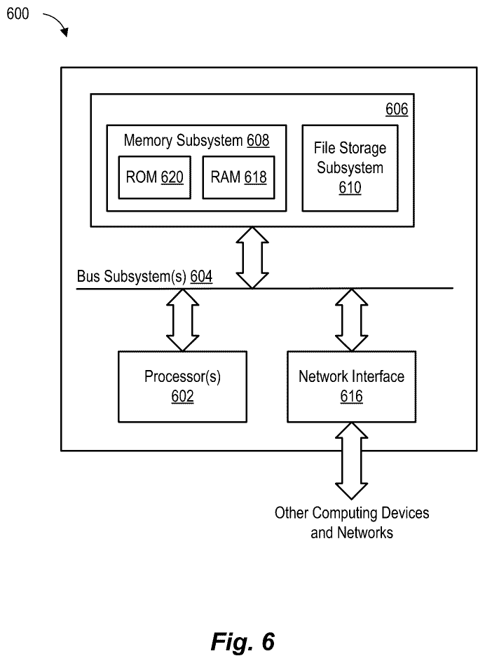

FIG. 6 depicts a simplified block diagram of an example computer system, which can be used to implement some of the techniques described in the foregoing disclosure. As shown in FIG. 6, system 600 includes one or more processors 602 that communicate with several devices via one or more bus subsystems 604. These devices may include a storage subsystem 606 (e.g., comprising a memory subsystem 608 and a file storage subsystem 610) and a network interface subsystem 616. Some systems may further include user interface input devices and/or user interface output devices (not shown).

Bus subsystem 604 can provide a mechanism for letting the various components and subsystems of system 600 communicate with each other as intended. Although bus subsystem 604 is shown schematically as a single bus, alternative embodiments of the bus subsystem can utilize multiple buses.

Network interface subsystem 616 can serve as an interface for communicating data between system 600 and other computer systems or networks. Embodiments of network interface subsystem 616 can include, e.g., Ethernet, a Wi-Fi and/or cellular adapter, a modem (telephone, satellite, cable, etc.), and/or the like.

Storage subsystem 606 includes a memory subsystem 608 and a file/disk storage subsystem 610. Subsystems 608 and 610 as well as other memories described herein are examples of non-transitory computer-readable storage media that can store executable program code and/or data that provide the functionality of embodiments of the present disclosure.

Memory subsystem 608 comprise one or more memories including a main random access memory (RAM) 618 for storage of instructions and data during program execution and a read-only memory (ROM) 620 in which fixed instructions are stored. File storage subsystem 610 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 600 is illustrative and many other configurations having more or fewer components than system 600 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, comprising: receiving historic time-series data associated with consumption of a resource on a virtual machine (VM), wherein each data point in the time-series data contains an actual usage value that represents historic actual usage of the resource by a user account, discretizing the historic time-series data by assigning each data point in the historic time-series data one of a plurality of discretized values, wherein each discretized value corresponding to one of a plurality of service tiers defines a commissionable quantity of the resource by the VM, and wherein the user account includes a resource setting set to one of the plurality of service tiers, analyzing the discretized historic time-series data, and adjusting the resource setting based on the analysis.

In one embodiment, discretizing the historic time-series data includes: retrieving the actual usage value corresponding to a data point, identifying a service tier from the plurality of service tiers having the smallest discretized value that is larger than the actual usage value, and assigning the discretized value corresponding to the identified service tier to the data point.

In one embodiment, analyzing the discretized historic time-series data includes: identifying at least one data point from the discretized historic time-series data as having the discretized value corresponding to the data point being equal to or less than the discretized value corresponding to a downsized service tier, wherein the downsized service tier is the service tier associated with the resource setting downsized, calculating a percentage based on the identified data points, and making a determination to downsize the service tier set in the resource setting when the percentage is larger than a first predefined threshold.

In one embodiment, adjusting the resource setting includes downsizing the service tier in response to the determination.

In one embodiment, analyzing the discretized historic time-series data further includes: identifying at least one data point from the discretized historic time-series data as having the discretized value corresponding to the data point being equal to or less than the discretized value corresponding to a downsized service tier, wherein the downsized service tier is the service tier associated with the resource setting downsized, calculating a percentage based on the identified data points, first determining that the percentage is less than a first predefined threshold and more than a second predefined threshold, second determining that there are more identified data points in a second half of the historic time-series data than in a first half of the historic time-series data, and making a determination to downsize the service tier based on the first determination and the second determination.

In one embodiment, analyzing the discretized historic time-series data further includes: calculating a density value of non-identified data points in the second half of the historic time-series data and updating a max density value based on the density value.

In one embodiment, analyzing the discretized historic time-series data further includes: identifying at least one data point from the discretized historic time-series data as having the discretized value corresponding to the data point being equal to or less than the discretized value corresponding to a downsized service tier, wherein the downsized service tier is the service tier associated with the resource setting downsized, first determining that there are more identified data points in a first half of the historic time-series data than in a second half of the historic time-series data, calculating a density value of the identified data points in the second half of the historic time-series data in response to the first determination, second determining that the density value is less than a max density, and making a determination to downsize the service tier based on the second determination.

In some embodiments, a system comprises one or more processors; a non-transitory computer-readable medium storing a program executable by the one or more processors, the program comprising sets of instructions for: comprising: receiving historic time-series data associated with consumption of a resource on a virtual machine (VM), wherein each data point in the time-series data contains an actual usage value that represents historic actual usage of the resource by a user account, discretizing the historic time-series data by assigning each data point in the historic time-series data one of a plurality of discretized values, wherein each discretized value corresponding to one of a plurality of service tiers defines a commissionable quantity of the resource by the VM, and wherein the user account includes a resource setting set to one of the plurality of service tiers, analyzing the discretized historic time-series data, and adjusting the resource setting based on the analysis.

In some embodiments, a non-transitory computer-readable medium stores a program executable by one or more processors, the program comprising sets of instructions for comprising: receiving historic time-series data associated with consumption of a resource on a virtual machine (VM), wherein each data point in the time-series data contains an actual usage value that represents historic actual usage of the resource by a user account, discretizing the historic time-series data by assigning each data point in the historic time-series data one of a plurality of discretized values, wherein each discretized value corresponding to one of a plurality of service tiers defines a commissionable quantity of the resource by the VM, and wherein the user account includes a resource setting set to one of the plurality of service tiers, analyzing the discretized historic time-series data, and adjusting the resource setting based on the analysis.

What is claimed is:

1. A method, comprising:
receiving historic time-series data associated with consumption of a resource on a virtual machine (VM), wherein each data point in the time-series data contains an actual usage value that represents historic actual usage of the resource by a user account;
discretizing the historic time-series data by assigning each data point in the historic time-series data one of a plurality of discretized values, wherein each discretized value corresponding to one of a plurality of service tiers defines a commissionable quantity of the resource by the VM, and wherein the user account includes a resource setting set to one of the plurality of service tiers;
analyzing the discretized historic time-series data; and
adjusting the resource setting based on the analysis.

2. The method as in claim 1, wherein discretizing the historic time-series data includes:
retrieving the actual usage value corresponding to a data point;
identifying a service tier from the plurality of service tiers having the smallest discretized value that is larger than the actual usage value; and
assigning the discretized value corresponding to the identified service tier to the data point.

3. The method as in claim 2, wherein analyzing the discretized historic time-series data includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
calculating a percentage based on the identified data points; and
making a determination to downsize the service tier set in the resource setting when the percentage is larger than a first predefined threshold.

4. The method as in claim 3, wherein adjusting the resource setting includes downsizing the service tier in response to the determination.

5. The method as in claim 2, wherein analyzing the discretized historic time-series data further includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
calculating a percentage based on the identified data points;
first determining that the percentage is less than a first predefined threshold and more than a second predefined threshold;
second determining that there are more identified data points in a second half of the historic time-series data than in a first half of the historic time-series data; and
making a determination to downsize the service tier based on the first determination and the second determination.

6. The method as in claim 5, wherein analyzing the discretized historic time-series data further includes:
calculating a density value of non-identified data points in the second half of the historic time-series data; and
updating a max density value based on the density value.

7. The method as in claim 2, wherein analyzing the discretized historic time-series data further includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
first determining that there are more identified data points in a first half of the historic time-series data than in a second half of the historic time-series data;
calculating a density value of the identified data points in the second half of the historic time-series data in response to the first determination;
second determining that the density value is less than a max density; and
making a determination to downsize the service tier based on the second determination.

8. A system comprising:
one or more processors;
a non-transitory computer-readable medium storing a program executable by the one or more processors, the program comprising sets of instructions for:
receiving historic time-series data associated with consumption of a resource on a virtual machine (VM), wherein each data point in the time-series data contains an actual usage value that represents historic actual usage of the resource by a user account;
discretizing the historic time-series data by assigning each data point in the historic time-series data one of a plurality of discretized values, wherein each discretized value corresponding to one of a plurality of service tiers defines a commissionable quantity of the resource by the VM, and wherein the user account includes a resource setting set to one of the plurality of service tiers;
analyzing the discretized historic time-series data; and
adjusting the resource setting based on the analysis.

9. The system of claim 8, wherein discretizing the historic time-series data includes:
retrieving the actual usage value corresponding to a data point;
identifying a service tier from the plurality of service tiers having the smallest discretized value that is larger than the actual usage value; and
assigning the discretized value corresponding to the identified service tier to the data point.

10. The system of claim 9, wherein analyzing the discretized historic time-series data includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
calculating a percentage based on the identified data points; and
making a determination to downsize the service tier set in the resource setting when the percentage is larger than a first predefined threshold.

11. The system of claim 10, wherein adjusting the resource setting includes downsizing the service tier in response to the determination.

12. The system of claim 9, wherein analyzing the discretized historic time-series data further includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
calculating a percentage based on the identified data points; and
first determining that the percentage is less than a first predefined threshold and more than a second predefined threshold;
second determining that there are more identified data points in a second half of the historic time-series data than in a first half of the historic time-series data; and
making a determination to downsize the service tier based on the first determination and the second determination.

13. The system of claim 12, wherein analyzing the discretized historic time-series data further includes:
calculating a density value of non-identified data points in the second half of the historic time-series data; and
updating a max density value based on the density value.

14. The system of claim 9, wherein analyzing the discretized historic time-series data further includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
first determining that there are more identified data points in a first half of the historic time-series data than in a second half of the historic time-series data;
calculating a density value of the identified data points in the second half of the historic time-series data in response to the first determination;
second determining that the density value is less than a max density;
making a determination to downsize the service tier based on the second determination.

15. A non-transitory computer-readable medium storing a program executable by one or more processors, the program comprising sets of instructions for:
receiving historic time-series data associated with consumption of a resource on a virtual machine (VM), wherein each data point in the time-series data contains an actual usage value that represents historic actual usage of the resource by a user account;
discretizing the historic time-series data by assigning each data point in the historic time-series data one of a plurality of discretized values, wherein each discretized value corresponding to one of a plurality of service tiers defines a commissionable quantity of the resource by the VM, and wherein the user account includes a resource setting set to one of the plurality of service tiers;
analyzing the discretized historic time-series data; and
adjusting the resource setting based on the analysis.

16. The non-transitory computer-readable medium of claim 15, wherein discretizing the historic time-series data includes:
retrieving the actual usage value corresponding to a data point;
identifying a service tier from the plurality of service tiers having the smallest discretized value that is larger than the actual usage value; and
assigning the discretized value corresponding to the identified service tier to the data point.

17. The non-transitory computer-readable medium of claim 16, wherein analyzing the discretized historic time-series data includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
calculating a percentage based on the identified data points; and
making a determination to downsize the service tier set in the resource setting when the percentage is larger than a first predefined threshold.

18. The non-transitory computer-readable medium of claim 16, wherein analyzing the discretized historic time-series data further includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
calculating a percentage based on the identified data points; and
first determining that the percentage is less than a first predefined threshold and more than a second predefined threshold;
second determining that there are more identified data points in a second half of the historic time-series data than in a first half of the historic time-series data; and
making a determination to downsize the service tier based on the first determination and the second determination.

19. The non-transitory computer-readable medium of claim 18, wherein analyzing the discretized historic time-series data further includes:
calculating a density value of non-identified data points in the second half of the historic time-series data; and
updating a max density value based on the density value.

20. The non-transitory computer-readable medium of claim 16, wherein analyzing the discretized historic time-series data further includes:
identifying at least one data point from the discretized historic time-series data as having the discretized value corresponding to the data point being equal to or less than the discretized value corresponding to a downsized service tier, wherein the downsized service tier is the service tier associated with the resource setting downsized;
first determining that there are more identified data points in a first half of the historic time-series data than in a second half of the historic time-series data;
calculating a density value of the identified data points in the second half of the historic time-series data in response to the first determination;
second determining that the density value is less than a max density;
making a determination to downsize the service tier based on the second determination.
